(19) United States
(12) Patent Application Publication
(10) Pub. No.: US 2007/0189356 A1
(43) Pub. Date: Aug. 16, 2007

(54) Exhaust buildup monitoring in semiconductor processing

(76) Inventors: Jonathan Pettit, Round Rock, TX (US); Raymond Joe, Austin, TX (US)

Correspondence Address: WOOD, HERRON & EVANS, LLP (TOKYO ELECTRON), 2700 CAREW TOWER, 441 VINE STREET, CINCINNATI, OH, 45202, US

(21) Appl. No.: 11/352,919

(22) Filed: Feb. 13, 2006

(51) Int. Cl. G01K 3/00; G01N 25/00

(52) U.S. Cl. 374/7; 374/137

(57) ABSTRACT

A system is provided for determining when the buildup of deposits in an exhaust line of a semiconductor wafer processing machine requires cleaning. Deposits in vacuum exhaust lines build up to where they eventually fail structurally, releasing particles that can contaminate equipment and processes. The time at which cleaning is required is often unpredictable, while frequent or early cleaning to avoid waiting too long unnecessarily reduces productivity. The invention provides for the monitoring of thermal properties on the inside of an exhaust line wall. Deposits cause changes in the monitored thermal properties. A heater and thermocouple can be used, for example, and the temperature at the thermocouple that is due to heat flow from the heater is measured. Buildups in the exhaust line affect heat flow to the sensor and are measurable as a decline in sensed temperature. Structural failure of the coating in the exhaust line leads to the eventual leveling off and fluctuation of the temperature measurement. Comparison or correlation of the sensed thermal property or a profile thereof with data stored under known exhaust line conditions is used to determine the condition of the exhaust line and signal when cleaning is most appropriate.

This invention relates to the reduction of particulate contamination in semiconductor processing and to the efficiency of such processing.

### BACKGROUND OF THE INVENTION

In semiconductor manufacturing, deposition processes must usually be performed with a minimum of particle generation. One of the sources of particle generation can be from the physical failure or breakdown of the buildup within the exhaust line leading from a deposition or other processing apparatus. This buildup typically accumulates from the reaction of process by-products downstream of the process chamber over repeated process runs. If this buildup breaks down in the exhaust line, particles are generated. Some of these particles can move upstream during the cycling of the system or can contaminate the environment around the processing equipment that can lead to contamination entering other adjacent processing systems.

To minimize or prevent failure of this buildup, a process exhaust line is typically cleaned before failure of the coatings on the walls of the exhaust line occurs. The cleaning can be done either in-situ, or, more commonly, by ex-situ cleaning in which the line is removed for cleaning.

A problem with the scheduling of exhaust line cleaning is to insure that the line is cleaned before a structural failure of the deposits within it that could cause a ruinous contamination of the process equipment. This scheduling is made difficult by the unpredictable growth rate of the deposit buildup. Conservative scheduling of the cleaning of the lines to insure that the cleaning is not deferred too long results in unnecessary downtime of the equipment and unnecessary increase of the cleaning costs.

Periodic invasive monitoring such as periodic visual inspection of exhaust lines can be used to avoid premature cleaning operations. However, the inspection itself reduces the productivity of the equipment, and the invasive monitoring itself can lead to the unnecessary production of particles.

Accordingly, there is a need for rendering the cleaning of exhaust lines in semiconductor wafer processing while maintaining efficient machine utilization.

### SUMMARY OF THE INVENTION

In accordance with principles of the present invention, the buildup in an exhaust line is determined by sensing thermal properties of the buildup and determining the need for cleaning the line based on the sensed thermal properties.

In accordance with certain embodiments of the invention, thermal properties, parameters or values that are due to the changing thermal mass in the exhaust line are sensed to create an evolving thermal profile signature over time. The evolving thermal profile signature can then be correlated, either empirically or theoretically, to a buildup thickness on the inside wall of the exhaust line.

In accordance with an embodiment of the invention, a heating element and temperature sensor are provided on the wall of the exhaust line and changes in temperature are sensed in response to changes in the energy applied to the heating element. Heat flow from the heating element to the sensor is affected by the buildup of coating on the inside of the exhaust line, which buildup may cover or surround the heating element, the sensor or both, or otherwise occupy the path of the heat flow from the heating element to the sensor. The sensed temperature function can be correlated with predetermined criteria and a decision made as to the nature of the buildup in the exhaust line based on the correlation.

The invention provides a monitoring function that is inexpensive in both material and maintenance. Simple and passive operation and data collection are provided. Invasive monitoring procedures are avoided while invasive cleaning and build up failure are minimized.

These and other objects and advantages of the present invention will be more readily apparent from the following detailed description of illustrated embodiments of the invention.

### DETAILED DESCRIPTION OF THE DRAWINGS

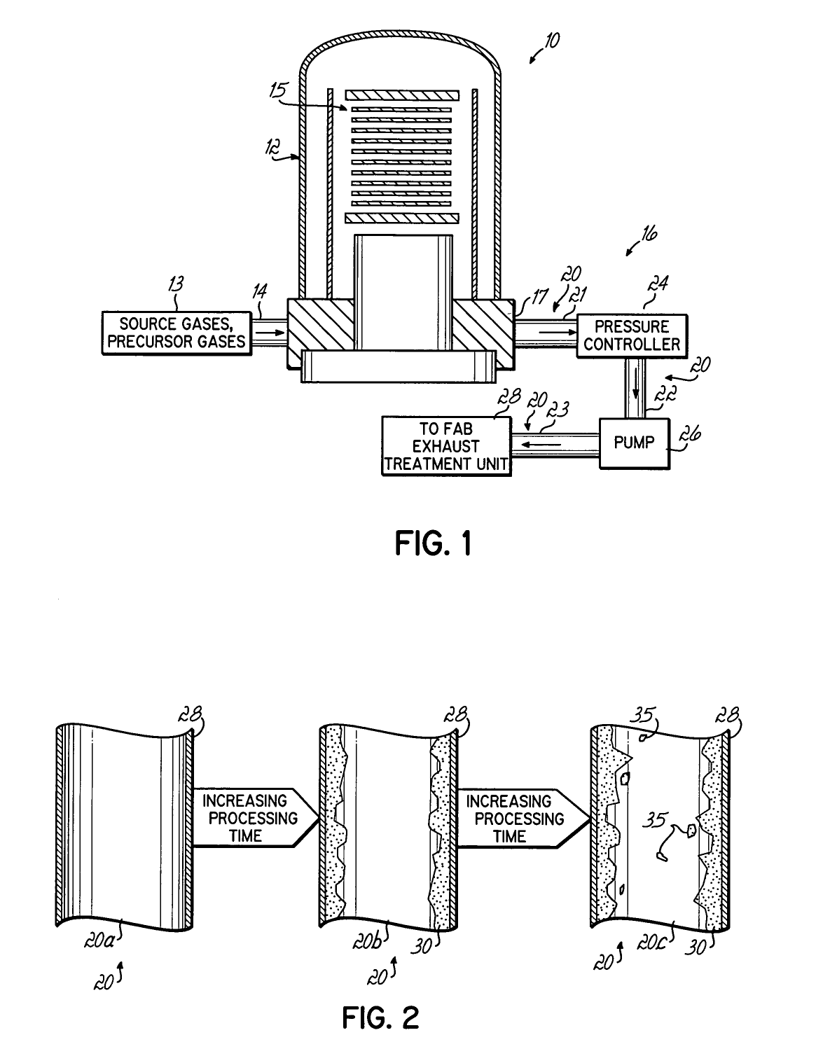

FIG. 1 is a schematic diagram of one form of a semiconductor wafer processing system according to one embodiment of the present invention.

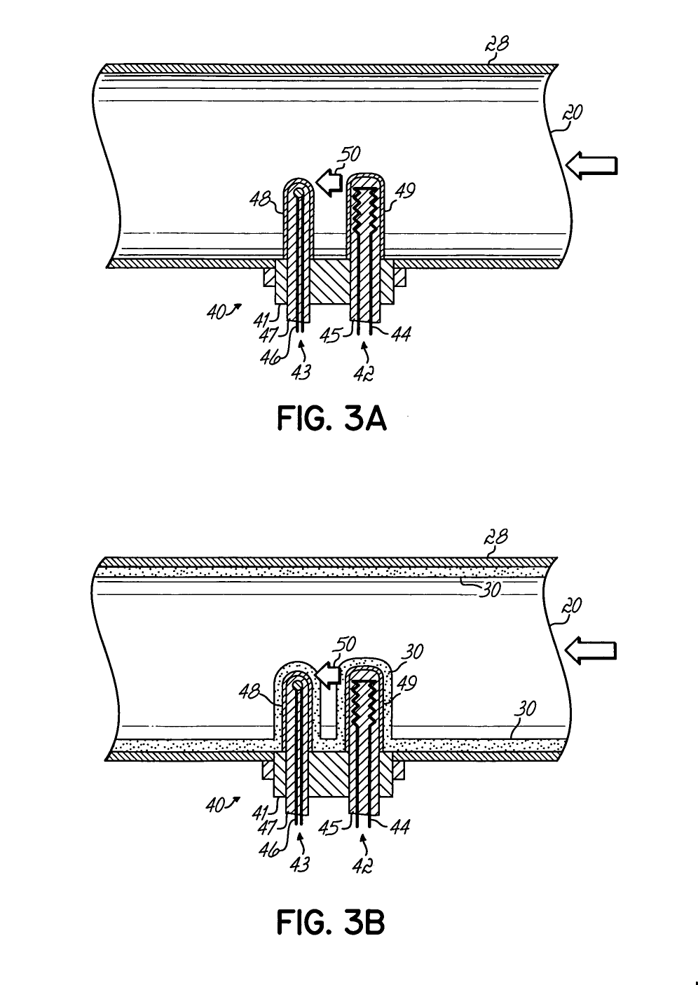

FIG. 2 is a diagram illustrating the progression of deposit buildup in a progression of cross-sections through an exhaust line of the system of FIG. 1.

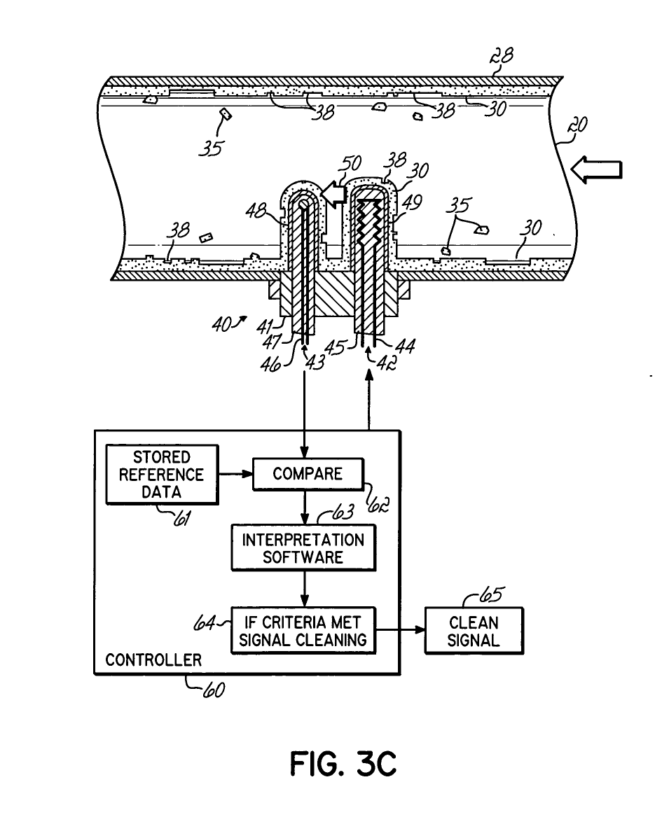

FIG. 3A is a cross-sectional diagram of an exhaust line provided with an embodiment of the present invention and in which the exhaust line is in an initial clean condition.

FIG. 3B is a cross-sectional diagram of the exhaust line of FIG. 3A having a buildup of deposits.

FIG. 3C is a cross-sectional diagram of the exhaust line of FIGS. 3A and 3B in which a buildup of deposits has progressed to the point of structural buildup failure.

### DETAILED DESCRIPTION OF EMBODIMENTS OF THE INVENTION

The diagram of FIG. 1 illustrates a semiconductor wafer processing system 10 which is, in the illustration, a batch chemical vapor deposition system having a gas supply system 13 connected to an inlet 14 of a vacuum processing chamber 12 in which are processed semiconductor wafers 15, and an outlet system 16 for removing spent gases from the chamber 12 connected to an outlet 17 of the chamber 12. While illustrated as a batch CVD system, the processing system 10 can be any type of semiconductor processing system that has a tendency to accumulate a buildup of deposits in exhaust lines of the outlet system 16. Such systems might include deposition and etching systems, thermal or other processing systems, physical, chemical systems or other processing systems having the problem solved by the invention.

The exhaust system 16 of the semiconductor wafer processing system 10 includes an exhaust line 20 in which is connected a pressure controller 24 and a vacuum pump 26. A section 21 of the exhaust line 20 connects the outlet 17 of the chamber 12 to the pressure controller 24, while an exhaust line section 22 connects the pressure controller to the vacuum pump 26. A further section of exhaust line 23 connects the pump 26 to a fabrication facility exhaust treatment unit 28.

In the operation of the system 10, the vacuum pump 26 draws process gas from the chamber 12 through the exhaust line 20. These gases carry byproducts of the process performed in the chamber 12 into and through the exhaust line 20. The byproducts include materials that may eventually form a solid coating on surfaces along the exhaust line 10. Initially, the exhaust line 20 will appear as line 20a in FIG. 2, in which a wall 28 of the exhaust line 20 is essentially clean. With increased process time, a buildup of deposits 30 collects on the inside of the wall 28, as represented by the line 20b in FIG. 2. Eventually, the buildup of deposits 30 reaches a thickness which will not sustain the physical and thermal stresses of system cycling, whereupon physical or structural failure of the buildup will begin, as shown in connection with the line 20c in FIG. 2. When such failure of the buildup occurs, particles 35 break off from the buildup 30 that was fixed to the chamber wall 28. At high vacuum, these particles move randomly in all directions and collide with gas atoms or other particles in the exhaust line 20, eventually propagating downstream. Statistically, some of these particles 35 will make their ways upstream toward the chamber while others can move into other parts of the system 10 or elsewhere in the facility. As a result, contamination and possible damage on wafers being processed can occur, particularly if operation of the system 10 continues after the buildup begins to fail.

The present invention provides for reliable determination of when the coating has buildup to the point that is has begun, or is about to, fail. One embodiment of the invention includes a buildup determining system 40, as illustrated in FIG. 3A. In FIG. 3A, exhaust line 20 is provided with a sensor 43 mounted in feed-through 41 in the wall 28 of the exhaust line 20. The sensor 43 is configured to measure thermal properties on the inside of the wall 28. The property measured can be heat flux, temperature, or some other property that changes as a result of the thickness or other condition of the buildup. With the embodiment of the buildup determining system 40, the sensor 43 is a thermocouple embedded in an insulator 47 enclosed in a metal sheath 48 that projects into the wall 28 from the outside of the exhaust line 20.

The preferred embodiment of the system 40 also includes a heater assembly 42 that may be also mounted in the feed-through 41 or in another manner to the inside of the wall 28 close to the sensor 43. The electrical heater assembly 42 includes an electric wire heating element 44 imbedded in an insulator 45 encased in a metal sleeve 49. The heater assembly 42 is operated in some predetermined manner, such as at a predetermined constant power level. When the system 40 having the heater assembly 42 and sensor 43 is mounted in the wall 28 of a clean exhaust line 20, as in line 20c of FIG. 2, and the system 10 is operated in a steady condition, the heating element 42 will achieve a constant temperature and a constant heat flux will flow to the thermocouple 43, as indicated by the arrow 50. This results in a steady and predictable output from the thermocouple 43.

As the system 10 continues to operate and a buildup of deposits 30 appears on the inside of the wall 28, the exhaust line 20 begins to appear as line 20b of FIG. 2, and the system 40 appears as illustrated in FIG. 3B. The buildup 30 occurs on the inside of the wall 28 and, in addition, on the heating assembly 42 and the sensor 43. The buildup 30 usually causes the heat flux from the heating assembly 42 to the sensor 43, represented by the arrow 51, to decline. The profile of the temperature reading from the sensor 43 as a function of time will follow a curve that can be correlated with theoretical or empirical curves from known buildup courses to provide an insight into the condition of the exhaust line.

As the system 10 continues further to operate, a buildup of deposits reaches a point at which particles 35 begin to flake off from the buildup 30 on the wall 28 of the exhaust line 20, as in line 20c of FIG. 2, and the system 40 appears as illustrated in FIG. 3C. The flaking is a result of the structural failure of the buildup 30, which results in cavities 38 appearing in the deposited coating 30 on the walls 28 of the exhaust line 20, including along the coating on the sensor 43 and heating assembly 42. The net rate of buildup 30 slows and begins to fluctuate. This leads to a slowing in the decline in the heat flow from the heating assembly 42 to the sensor 43, as indicated at the arrow 52, which causes a slowing of the decline of the temperature sensed by the sensor 43. Eventually the heat flow levels off and fluctuates leading to a leveling off and fluctuation in the temperature reading. The temperature profile as this occurs will compare with other profiles of a buildup approaching a structural failure.

In the system 40, the heating element 44 and sensor 46 are connected to a controller 60, which includes a memory 61 which stores reference measurement values and heat flow and temperature profiles that serve as reference criteria. The controller also includes a processor 62 programmed to sample and store readings from the sensor 43 and to compare those readings with the reference criteria in memory 61. The results of the comparison are processed by interpretation software 63 that determines the condition of the exhaust line 20, to which is applied decision making logic 64 which decides when to generate an output signal 65 to indicate that cleaning of the exhaust line 20 is due.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A method of evaluating the buildup of deposits on the inside of an exhaust line of a semiconductor processing system comprising:
sensing thermal information from the inside of the exhaust line of a semiconductor processing apparatus;
correlating the sensed information with thermal response information related to deposit buildups inside of an exhaust line; and
signaling for the cleaning of the exhaust line based on results of the correlating of the sensed information with the thermal response information.

2. The method of claim 1 wherein:
the correlating of the sensed information with thermal response information related to deposit buildups includes comparing a thermal profile signature from the sensor with a stored thermal profile signature of a declining heat flux due to a predetermined thickness increase of a buildup of deposits; and
signaling for the cleaning of the exhaust line based on correlation between the thermal profile signature from the sensor and the stored thermal profile signature.

3. The method of claim 1 wherein:
the correlating of the sensed information with thermal response information related to deposit buildups includes comparing a thermal profile signature from the sensor with a stored thermal profile signature of fluctuating heat flux due to a physical failure of a buildup of deposits within the exhaust line; and
signaling for the cleaning of the exhaust line based on correlation between the thermal profile signature from the sensor and the stored thermal profile signature.

4. The method of claim 1 wherein:
the sensing of the thermal information from the inside of the exhaust line includes sensing temperature with a temperature sensor;
the thermal response information related to deposit buildups inside the exhaust line includes temperature information relating to heat flow through material constituting the buildup.

5. The method of claim 1 further comprising:
introducing thermal energy into the exhaust line;
the sensing of the thermal information including sensing a temperature responsive to the introduced thermal energy;
the correlating of the sensed thermal information with thermal response information includes comparing the sensed temperature with a temperature response relationship to the introduced thermal energy under various buildup conditions.

6. The method of claim 1 further comprising:
introducing thermal energy into the exhaust line;
the sensing of the thermal information including sensing a temperature responsive to the introduced thermal energy;
the correlating of the sensed thermal information with thermal response information includes comparing the sensed temperature with a temperature response relationship to introduced thermal energy under various buildup conditions.

7. The method of claim 1 wherein:
the sensing of the thermal information from the inside of the exhaust line includes sensing temperature with a temperature sensor;
the thermal response information related to deposit buildups inside the exhaust line includes temperature information relating to heat flow through material constituting the buildup; and
the correlating of the sensed thermal information with thermal response information includes comparing the sensed temperature with criteria for determining when the sensed temperature indicates a heat flow through the material commensurate with buildup conditions determined ready for cleaning of the exhaust line.

8. A semiconductor wafer processing apparatus comprising:
a processing chamber;
an exhaust line connected to the processing chamber;
a thermal sensor situated inside of the exhaust line and positioned such that a buildup of deposits on the inside of an exhaust line affects heat flow to the sensor;
a controller having an input connected to the sensor and programmed to interpret an output signal from the sensor for the effects on the heat flow to the sensor of the buildup of deposits on the inside of the exhaust line and, in response to the interpretation, to output a signal indicating the condition of the buildup indicating that the buildup is at a predetermined condition.

9. The apparatus of claim 6 further comprising:
a heat source situated in the exhaust line in proximity to the thermal sensor and positioned such that a buildup of deposits alter the heat flow from the heat source to the sensor.

10. The apparatus of claim 6 further comprising:
a memory having stored therein data of a thermal profile signature representative of a buildup in the predetermined condition; and
the controller being programmed to compare a thermal profile signature from the thermal sensor with the stored data and to produce an alert signal when the thermal profile signature from the sensor compares with the stored data.
